(19) United States
(12) Patent Application Publication
(10) Pub. No.: US 2013/0000066 A1
(43) Pub. Date: Jan. 3, 2013

(54) SCREEN CLEANING DEVICE AND ASSOCIATED METHODS

(76) Inventor: Robert Skelton, Edgewater, FL (US)

(21) Appl. No.: 13/536,071

(22) Filed: Jun. 28, 2012

Related U.S. Application Data
(60) Provisional application No. 61/503,605, filed on Jun. 30, 2011.

(51) Int. Cl. A47L 25/00; B23P 17/04

(52) U.S. Cl. 15/209.1; 29/428

(57) ABSTRACT

A screen cleaning device and method of making the same is provided having a support member, a cleaning member that is matingly connectable to the support member, and a retainer member. The cleaning member may include a pad and a covering overlying the pad. The cleaning member may be partially carried by an interior portion of the support member, and the retainer member may slidably fit about the cleaning member. The retainer member may be fastenable to the support member to fasten the cleaning member to the support member.

### RELATED APPLICATIONS

This application is related to and claims the benefit of U.S. Provisional Patent Application Ser. No. 61/503,605 titled iERASER Screen Cleaning Device on Jun. 30, 2011, the entire contents of each of which are incorporated herein by reference.

### FIELD OF THE INVENTION

The present invention relates to the field of electronic devices and, more specifically, to the field of cleaning electronic devices.

### BACKGROUND OF THE INVENTION

As technology continues to evolve, it consistently brings forth new problems. With the rise in popularity of touch screens in electronic devices, the need to remove residue from those screens has also arisen. Simply using a touch screen naturally contributes to residue left on the screen, due to natural oils in the skin. Other factors may contribute to the buildup of residue on screens, such as lotions, air pollution, and humidity. Aside from being unsightly, touch screens covered in residue do not function as well as their clean counterparts. As such, a need exists to remove residue from touch screens

Previous attempted solutions include simple cloths, but these require the use of fingers to propel the cloth, sometimes with great pressure. This can be uncomfortable for users, and may be inefficient, as users may have to cover an area a second time due to inconsistent pressure applied using the cloth. A need exists for an ergonomic, efficient tool for cleaning the screen of an electronic device.

### SUMMARY OF THE INVENTION

With the foregoing in mind, the present invention is provided by a screen cleaning device having a support member and a cleaning member that is matingly connectable to the support member, the cleaning member including a pad, and a covering overlying the pad. The screen cleaning device may additionally include a retainer member. The cleaning member may be partially carried by an interior portion of the support member. Additionally, the retainer member may slidably fit about the cleaning member and may be fastenable to the support member to fasten the cleaning member to the support member.

The pad may include an insert member and a block member which may be carried by the insert member. The block member may also be adhesively connected to the insert member. The insert member may include a plurality of tabs having an orientation, and the support member may include a respective plurality of tab receiving recesses formed therein having an orientation substantially similar to the orientation of the plurality of tabs. The plurality of tabs of the insert member may matingly engage the respective plurality of tab receiving recesses formed in the support member. The covering may be provided by a microfiber material, a suede material, a micro-suede material, or a soft fabric material. Additionally, the block member may be provided by a hard foam material or a felt material.

The support member may include a plurality of fastening material members. The retainer member may be fastened to the support member using an ultrasonic welding process that may cause the plurality of fastening material members to melt and adhere the retainer member to the support member. The retainer member and/or the support member may include fastening members. Further, the support member and/or the retainer member may include respective fastening member recesses. The fastening members and the respective fastening member recesses may matingly engage one another to fasten the retainer member to the support member. Alternatively, the retainer member may be fastenable to the support member using a male/female fastening system.

An alternate embodiment of a screen cleaning device is also provided, the screen cleaning device having a support member that includes an outer surface, edges having an arcuate shape that extend from the outer surface, the edges having a top surface that is substantially flat, inner side surfaces that are concave, and outer side surfaces that are convex. In an alternative embodiment, the top surface may be rounded, curved, or tapered. The support member may also include an inner surface opposite the outer surface, a plurality of tab receiving members formed in the inner side surface of the edges, and a plurality of fastening material members positioned on the top surface of the edges.

The screen cleaning device may also include a cleaning member having an insert member, which may have a substantially similar shape as the inner surface of the support member, and dimensions that are smaller than the inner surface of the support member so that the insert member may be carried by the support member. The cleaning member may also include a plurality of tabs extending outwardly from the insert member and corresponding to the configuration of the plurality of tab receiving members. Additionally, the cleaning member may also include a block member attached to the insert member and a covering which may be positioned to overlie the block member.

The screen cleaning device may also include a retainer member that may slidably fit about the cleaning member. The retainer member may be fastenable to the support member to fasten the cleaning member to the support member. The retainer member may have outer peripheral wall members and an opening therebetween, the opening being sized to accommodate the cleaning member. The covering may be secured over the block member by the retainer member, and the retainer member may be connectable to the support member using the fastening material members.

In an alternative embodiment, the present invention is provided by a screen cleaning device having a support member and a cleaning member. The support member may be configured to include an interior space and to permit attachment to a surface of an external member. Additionally, the support member may include a cut-out to facilitate the disposal and removal of the cleaning member within the interior space. The cleaning member may include a filament and a covering, material disposed substantially about and covering the filament. The filament may be formed into a shape configured to generally conform to the interior space of the support member. The cleaning member may be shaped and dimensioned so as to facilitate disposal and removal within the interior space of the support member by permitting the cleaning member to slide through an opening of the support member.

A method of manufacturing a screen cleaning device that includes a support member, a cleaning member that is matingly connectable to the support member, and a retainer member, is also provided. The method may include positioning a portion of the cleaning member to be carried by an interior portion of the support member and slidably positioning the retainer member about the cleaning member to fasten the support member to the cleaning member. The cleaning member may include a pad and a covering overlying the pad. The pad may include an insert member and a block member carried by the insert member. The method may further include adhesively connecting the block member to the insert member.

The insert member may include a plurality of tabs having an orientation, and the support member may include a respective plurality of tab receiving recesses formed therein having an orientation substantially similar to the orientation of the plurality of tabs. The method may then further include matingly engaging the plurality of tabs of the insert member with the respective plurality of tab receiving recesses formed in the support member. The support member may also include a plurality of fastening material members, and the retainer member may be fastened to the support member using an ultrasonic welding process. The ultrasonic welding process may cause the plurality of fastening material members to melt and adhere the retainer member to the support member.

### BRIEF DESCRIPTION OF THE DRAWINGS

FIG. 1 is a bottom perspective view of a screen cleaning device according to an embodiment of the present invention.

FIG. 2 is a top perspective view of the screen cleaning device illustrated in FIG. 1.

FIG. 3 is an exploded view of the screen cleaning device illustrated in FIG. 1.

FIG. 4a is an elevation view of a support member of a screen cleaning device according to an embodiment of the present invention.

FIG. 4b is a perspective view of an alternative embodiment of the support member of the screen cleaning device of the present invention.

FIG. 5 is an elevation view of a pad of a screen cleaning device according to an embodiment of the present invention.

FIG. 6 is an elevation view of a retainer member of a screen cleaning device according to an embodiment of the present invention.

FIG. 7 is a side elevation view of components of a screen cleaning device before fastening according to an embodiment of the present invention.

FIG. 8 is a side elevation view of the screen cleaning device illustrated in FIG. 7 after fastening according to an embodiment of the present invention.

FIG. 9 is a perspective view of a screen cleaning device according to an embodiment of the present invention.

FIG. 10 is a perspective view of a support member of the screen cleaning device illustrated in FIG. 9.

### DETAILED DESCRIPTION OF THE PREFERRED EMBODIMENT

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

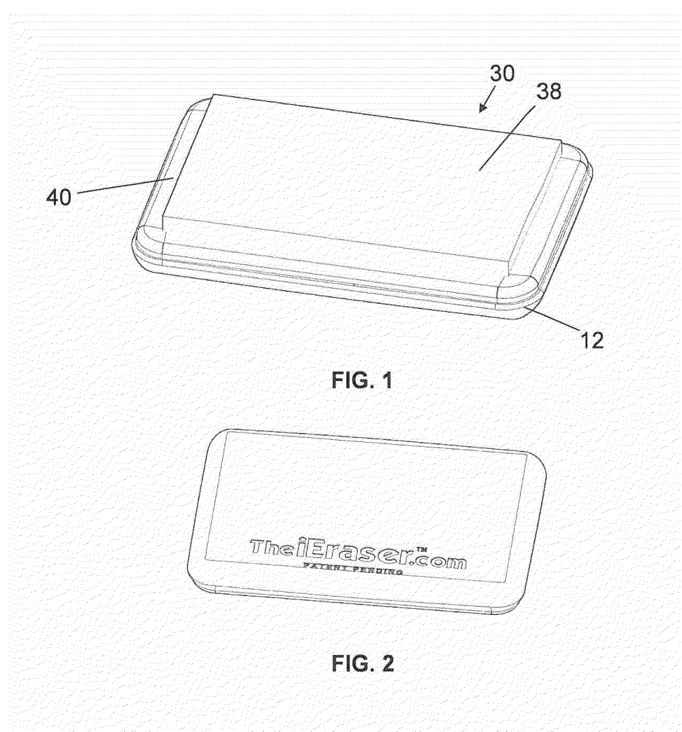

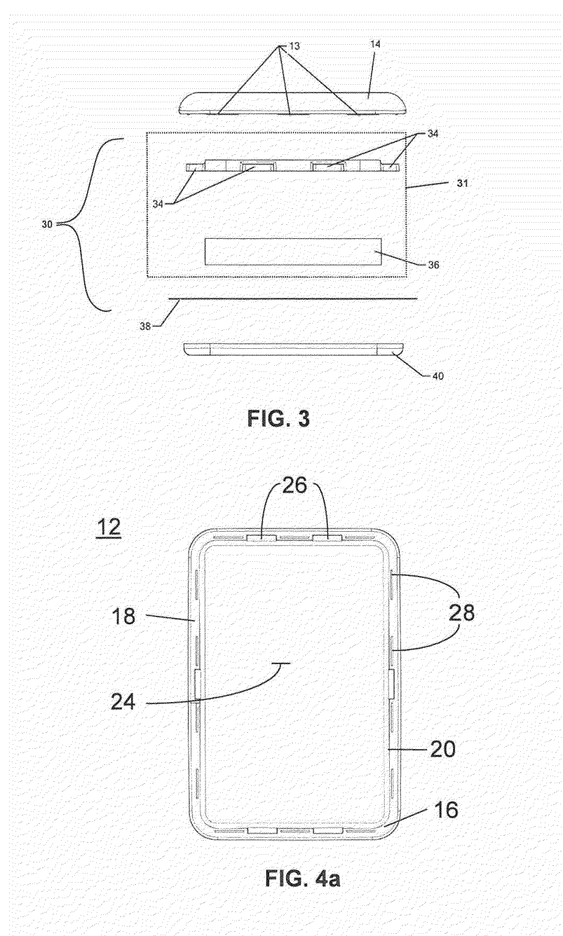

Referring now to FIGS. 1-8, a screen cleaning device 10 will now be described in greater detail. Referring initially to FIGS. 1 and 2, a screen cleaning device 10 is shown having a support member 12 and a cleaning member 30 that is matingly connectable to the support member 12. The cleaning member 30 may include a pad 31 (perhaps best shown in FIG. 3 or 5), and a covering 38 overlying at least a portion the pad 31. The cleaning member 30 may be partially carried by an interior portion of the support member 12. Additionally, the screen cleaning device 10 may also include a retainer member 40, which may slidably fit about the cleaning member 30 and may be fastenable to the support member 12 in order to fasten the cleaning member 30 to the support member 12.

The pad 31 of the screen cleaning device 10 may include an insert member 32 and a block member 36 that may be carried by the insert member 32, as shown in FIG. 3. Both the insert member 32 and the block member 36 may have a generally rectangular configuration, although other shapes are contemplated and included within the scope of the invention, including, without limitation, circles, ovoids, triangles, squares, and any other polygon. Furthermore, it is contemplated and within the scope of the invention that the insert member 32 and the block member may be configured to have different shapes.

The block member 36 may be adhesively connected to the insert member 32. Furthermore, other methods of connection of the block member 36 to the insert member 32 may include any method that sufficiently connects the block member 36 to the insert member 32 to resist the forces experienced by the screen cleaning device including, without limitation, glues, fasteners and interference fits, and are included within the scope and spirit of the present invention. Further, the above examples are exemplary in nature and not limiting.

The block member 36 may be provided by a hard foam material, a felt material, or any firm padding material, including a foam of medium hardness. It is contemplated and within the scope of the invention that the covering 38 and the block member 36 may be formed of materials that exhibit the described physical properties.

The insert member 32 may include a plurality of tabs 34. The plurality of tabs 34 may be positioned about the periphery of the insert member 32. Furthermore, the plurality of tabs 34 may have an orientation with respect to the insert member 32.

The covering 38 may be a generally thin material disposed substantially about and covering the block member provided by a microfiber material, a suede material, a micro-suede material, or any other soft material suitable for removing residue from touch screens without damaging the screen.

Referring still to FIG. 3, the support member 12 may be configured to attach to the cleaning member 30. Furthermore, the support member 12 may be configured to conform to the shape of at least one of the insert member 32 and the block member 36. The support member 12 may include a plurality of tab receiving recesses 26 formed therein. The plurality of tab receiving recesses 26 may also have an orientation substantially similar to the orientation of the plurality of tabs 34. The plurality of tabs 34 of the insert member 32 may be configured to matingly engage with the plurality of tab receiving recesses 26 formed in the support member 12, thereby attaching the cleaning member 30 to the support member 12.

The support member 12 of the screen cleaning device 10 may also include one or more fastening material members 13. The fastening material members 13 may be formed of any material that facilitates the attachment of the retainer member 40 to the support member 12.

The retainer member 40 may be fastened to the support member 12 using an ultrasonic welding process that may cause the fastening material members 13 to melt and adhere the retainer member 40 to the support member 12. Ultrasonic welding may be known by such skilled artisans as an industrial technique. This technique applies high-frequency ultrasonic vibrations to pieces held together in order to create a solid weld. The vibrations cause local melting of material, particularly in thermoplastics, allowing for a connection to be made, even between dissimilar materials. For example, one type of ultrasonic welding apparatus is disclosed in U.S. Patent Application Publication No. 2008/0023529, the entire contents of which are incorporated herein by reference.

Alternately, at least one of the retainer member 40 and the support member 12 may include fastening members. At least one of the support member 12 and the retainer member 40 may include respective fastening member recesses. The fastening members and the respective fastening member recesses may matingly engage one another to fasten the retainer member 40 to the support member 12. Still alternately, the retainer member 40 may be fastenable to the support member 12 using a male/female fastening system. Furthermore, any other suitable method of attaching the retainer member 40 to the support member are contemplated and intended to be included within the scope of the invention.

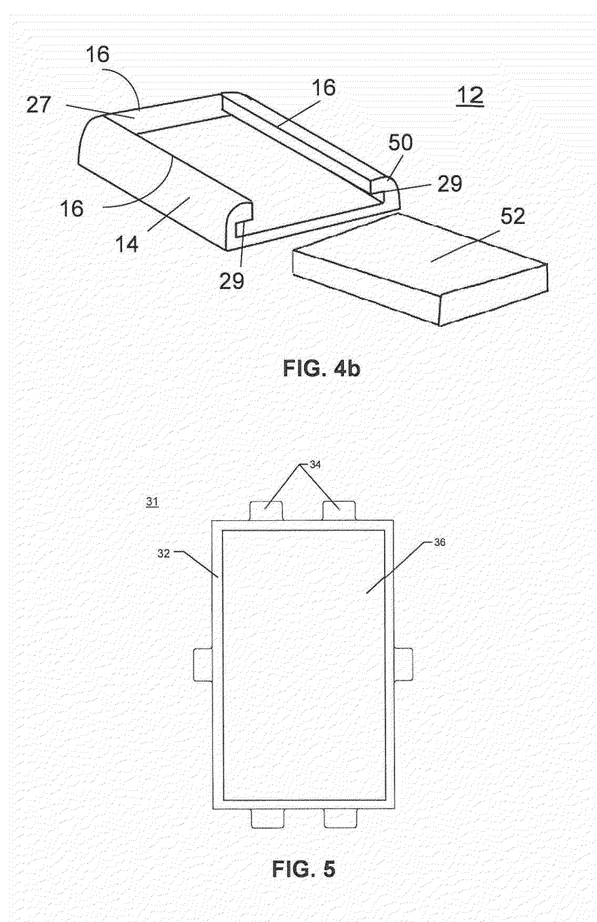

Referring now to FIG. 4a, the support member 12 of the screen cleaning device according to an embodiment of the present invention will now be discussed in greater detail. The support member 12 may include an outer surface 14 (perhaps best shown on FIG. 3), and edges 16. The edges 16 may have an arcuate shape, and may extend from the outer surface 14. The edges 16 may have a top surface 18 that may be substantially flat, inner side surfaces 20 that may be concave, and outer side surfaces 22 that may be convex. In alternative embodiments, the top surface 18 may be rounded, curved, or tapered. The support member 12 may also include an inner surface 24 generally opposite the outer surface 14. Additionally, the tab receiving members 26 may be formed in the inner side surface 20 of the edges 16. Furthermore, the fastening material members 13 may be positioned on the top surface 18 of the edges 16. Each of the tab receiving members 26 and the fastening material members 13 may be optionally positioned relatively closer to either the inner side surfaces 20 or the outer side surfaces 22.

Referring now to FIG. 4b, the support member 12 of an alternative embodiment will now be discussed in greater detail. The outer surface 14 of the support member 12 may further include a recessed receiving section 27. The recessed receiving section 27 may include a section of the outer surface 14 extending from one of the edges 16, defined as a portal edge 50, to an area bounded by the remainder of the other edges 16. Furthermore, the recessed receiving section 27 may further include a shelf 29 within the recessed receiving section 27. The shelf 29 may be configured to define a section of the recessed receiving section 27 that permits a plate 52 to be disposed therein. When the plate 52 is disposed within the recessed receiving section 27, the shelf 29 may constrain the movement of the plate 52 in a direction generally orthogonal to the outer surface 14. The plate 52 may be disposed within the recessed receiving section 27 by sliding the plate 52 into the recessed receiving section through the portal edge 50 and into an area generally underneath the shelf 29 until substantially all of the plate 52 is disposed within the recessed receiving section 27. Similarly, the plate 52 may be removed from the recessed receiving section 27 by sliding the plate 52 out of the recessed receiving section 27 through the portal edge 50.

In some embodiments, the plate 52 may be formed of a transparent or translucent material. When the plate 52 is formed of transparent or translucent material, various surfaces of the recessed receiving section 27 may be visible through the plate 52. Optionally, objects may disposed within the recessed receiving section 27 and be viewable through the plate 52. In an embodiment, the object may be a thin sheet of material that may be disposed between a lower surface of the recessed receiving section 27 and the plate 52. The thin sheet of material may include pictures, photographs, drawings, designs, text, or any other visible works that may be perceived through the plate 52.

Referring now additionally to FIG. 5, the pad 31 of the cleaning member 30 (shown in greater detail in FIG. 3) of the screen cleaning device 10 according to an embodiment of the present invention will now be discussed in greater detail. The pad 31 may include an insert member 32 having a shape generally conforming to the shape of the inner surface 24 of the support member 12. The insert member 32 may, however, have dimensions that are smaller than the inner surface 24 of the support member 12 so that the insert member 32 may be carried by and disposed at least partially within the support member 12. The pad 31 of the cleaning member 30 may also include tabs 34 that may extend outwardly from the insert member 32. The tabs 34 may correspond to the configuration of the tab receiving members 26, facilitating the attachment of the pad 31 of the cleaning member 30 to the support member 12. Each of the tabs 34 may be positioned within one of the tab receiving members 26, thereby constraining movement of the insert member 32 with respect to the support member, thereby permitting the cleaning member 30 to be carried more readily by the support member 12. A block member 36 may be attached to the insert member 32 substantially as described hereinabove, and a covering 38 may be positioned to overlie the block member 36, as perhaps best shown in FIG. 3.

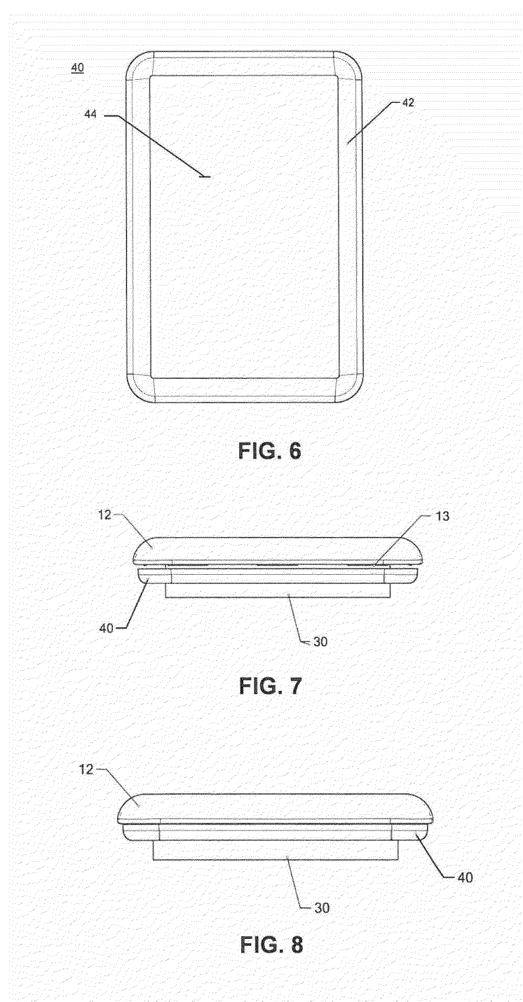

Referring still additionally to FIG. 6, the retainer member 40 of the screen cleaning device 10 will now be discussed in greater detail. The retainer member 40 may slidably fit about the cleaning member 30, and may be fastenable to the support member 12, thereby fastening the cleaning member 30 to the support member 12 (FIG. 3). The retainer member 40 may include outer peripheral wall members 42 and an opening 44 defined by the outer peripheral wall members 42. The opening 44 may be configured to accommodate slidably fitting about the cleaning member 30. More specifically, the opening 44 may be configured to have a shape generally conforming to the block member 36 and have dimensions at least slightly greater than the block member 36, thereby permitting at least a portion of the block member to be disposed within the opening 44. Although the appended figures illustrate an embodiment of the screen cleaning device 10 in which the cleaning member 30 slidably engages an opening 44 in the retainer member 40, many other configurations to connect the cleaning member to the retaining member are contemplated and meant to be included in the scope of the present invention, as will be discussed in greater detail below.

The retainer member 40 may secure the covering 38 over the block member 36. For instance, the retainer member may compress a portion of the covering 38 between the retainer member 40 and the support member 12. Moreover, the force of the compression may be sufficiently strong to prevent the portion of the covering 38 between the retainer member 40 and the support member 12 from moving. In an alternative embodiment, a glue or adhesive may be used to attach the covering 38 to at least one of the retainer member 40 and the support member 12. These examples are illustrative only and non-limiting, and all other suitable methods of constraining the covering 38 are contemplated and within the scope of the invention.

Furthermore, the retainer member may be connectable to the support member 12 using any of the methods of attachment described hereinabove, including the fastening material members 28.

Referring back to FIG. 3, a method of manufacturing a screen cleaning device 10 including a support member 12, a cleaning member 30 that is matingly connectable to the support member 12, and a retainer member 10 will be discussed. The method may include positioning a portion of the cleaning member 30 to be carried by an interior portion of the support member 12, and slidably positioning the retainer member 40 about the cleaning member 30 in order to fasten the support member 12 to the cleaning member 30. The cleaning member 30 may include a pad 31 and a covering 38 overlying the pad 31.

The pad 31 may include an insert member 32 and a block member 36 carried by the insert member 32. The method may further include adhesively connecting the block member 36 to the insert member 32. The insert member 32 may include tabs 34 having an orientation, and the support member 12 may include tab receiving recesses 26 formed therein. The tab receiving recesses 26 may have an orientation substantially similar to the orientation of the tabs 34. The method may then include matingly engaging the tabs 34 of the insert member 32 with the tab receiving recesses 26 formed in the support member 12.

Referring now to FIG. 7, and additionally to FIG. 8, the support member 12 may additionally include a plurality of fastening material members 13. The retainer member 40 may then be fastened to the support member 12 using an ultrasonic welding process that may cause the fastening material members 13 to melt and adhere the retainer member 40 to the support member 12. Alternately, at least one of the retainer member 40 and the support member 12 may include fastening members. At least one of the support member 12 and the retainer member 40 may also include a respective plurality of fastening member recesses. The method may then include matingly engaging the fastening members to the respective plurality of fastening member recesses to fasten the retainer member 40 to the support member 12. Still alternately, the retainer member 40 may be fastened to the support member using a male/female fastening system.

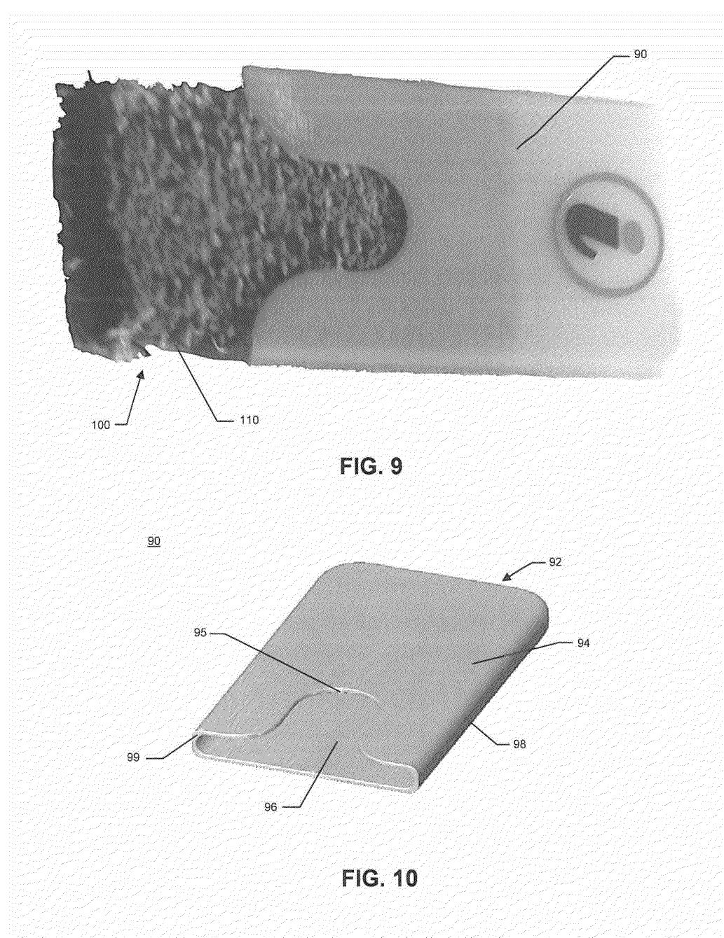

In an alternative embodiment as depicted in FIGS. 9-10, the present invention is provided by a support member 90 and a cleaning member 100. Turning now to FIG. 10, an embodiment of the support member 90 is shown in greater detail. The support member 90 may have a first end 92, a first wall 94, a second wall 96, sidewalls 98, and a second end 99 opposite the first end 92 that cooperate to define an interior space. The second end 99 may be open, permitting the positioning of the cleaning member 100 within the interior space. The support member 90 may be configured to permit attachment to a surface of an external member. More specifically, an outside surface (not shown) of the second wall 96 may be attached to another surface, for instance, a surface of an electronic device. Any suitable method of attachment may be used to attach the support member 90 to the surface of the external member, including, without limitation, glues, adhesives, tapes, suction, clips, and magnets.

Additionally, the first wall 94 may include a cut-out 95 positioned substantially towards and in communication with the opening of the second end 99 so as to form a continuous opening. The cut-out 95 may be of any size and shape. In the present embodiment, the cut-out 95 has a semicircular end and extends towards the second end 99. The cut-out may be configured to facilitate the disposal and removal of the cleaning member 100 within the interior space. For example, the cut-out 95 may be dimensioned to permit a finger or thumb to interface with a cleaning member 100 disposed within the interior space and slide the cleaning device through the opening at the second end 99 out of the support member 90. Alternatively, the cleaning member 100 may slide so that only a portion of the cleaning member 100 is positioned external the interior space.

The cleaning member 100 will now be discussed in greater detail. Referring to FIG. 9, the cleaning member 100 may include a filament (not shown) and a covering 110. The covering 110 may be material disposed substantially about and covering the filament provided by a microfiber material, a suede material, a micro-suede material, or any other soft material suitable for removing residue from touch screens without damaging the screen. The filament may be formed of any material that permits the disposal of the covering 110 about the filament and, optionally, facilitates attachment of the covering 110 thereto, including, without limitation, plastics, polymers, metals, metal alloys, woods, and composite materials.

The filament may be formed into any shape or geometry, and may be formed into a shape configured to generally conform to the interior space of the support member 90. Moreover, the dimensions of the filament may be configured to accommodate the additional thickness provided by disposal of the covering 110 about the filament such that the shape and dimensions of the cleaning member 100, as defined by the covering 110 being disposed about the filament, permit disposal of the cleaning member 100 within the interior space of the support member 90. Additionally, the cleaning member 100 may be shaped and dimensioned so as to facilitate disposal and removal within the interior space of the support member 90 by permitting the cleaning device to slide through the opening at the second end 99.

In an alternative embodiment, the cleaning member 100 may comprise only material such as microfiber material, a suede material, a micro-suede material, or any other soft material suitable for removing residue from touch screens without damaging the screen, and not include a filament.

Although the device in the above embodiments is pictured as substantially rectangular, the device may encompass any number of shapes, including triangular, circular, ovoid, square, rhomboid, or any other suitable polygon while still accomplishing the goals and features of the present invention.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A screen cleaning device comprising:
a support member;
a cleaning member that is matingly connectable to the support member, the cleaning member comprising
a pad, and
a covering overlying the pad; and
a retainer member;
wherein the cleaning member is partially carried by an interior portion of the support member;
wherein the retainer member slidably fits about the cleaning member and is fastenable to the support member to fasten the cleaning member to the support member.

2. A screen cleaning device according to claim 1 wherein the pad comprises an insert member and a block member carried by the insert member.

3. A screen cleaning device according to claim 2 wherein the block member is adhesively connected to the insert member.

4. A screen cleaning device according to claim 2 wherein the insert member comprises a plurality of tabs having an orientation; wherein the support member includes a respective plurality of tab receiving recesses formed therein having an orientation substantially similar to the orientation of the plurality of tabs; and wherein the plurality of tabs of the insert member matingly engage the respective plurality of tab receiving recesses formed in the support member.

5. A screen cleaning device according to claim 2 wherein the covering is provided by at least one of a microfiber material, a suede material, a micro-suede material, and a soft fabric material; and wherein the block member is provided by at least one of a hard foam material and a felt material.

6. A screen cleaning device according to claim 1 wherein the support member comprises a plurality of fastening material members; and
wherein the retainer member is fastened to the support member using an ultrasonic welding process that causes the plurality of fastening material members to melt and adhere the retainer member to the support member.

7. A screen cleaning device according to claim 1 wherein at least one of the retainer member and the support member includes fastening members; wherein at least one of the support member and the retainer member includes respective fastening member recesses; and wherein the fastening members and the respective fastening member recesses matingly engage one another to fasten the retainer member to the support member.

8. A screen cleaning device according to claim 1 wherein the retainer member is fastenable to the support member using a male/female fastening system.

9. A screen cleaning device comprising:
a support member comprising
an outer surface,
edges having an arcuate shape that extend from the outer surface, the edges having a top surface that is substantially flat, inner side surfaces that are concave, and outer side surfaces that are convex,
an inner surface opposite the outer surface,
a plurality of tab receiving members formed in the inner side surface of the edges, and
a plurality of fastening material members positioned on the top surface of the edges;
a cleaning member comprising
an insert member having a substantially similar shape as the inner surface of the support member, and dimensions that are smaller than the inner surface of the support member so that the insert member is carried by the support member,
a plurality of tabs extending outwardly from the insert member and corresponding to the configuration of the plurality of tab receiving members,
a block member attached to the insert member, and
a covering positioned to overlie the block member; and
a retainer member that slidably fits about the cleaning member and is fastenable to the support member to fasten the cleaning member to the support member, the retainer member comprising outer peripheral wall members and an opening therebetween, the opening being sized to accommodate the cleaning member;
wherein the covering is secured over the block member by the retainer member; and
wherein the retainer member is connectable to the support member using the fastening material members.

10. A screen cleaning device according to claim 9 wherein the block member is adhesively connected to the insert member.

11. A screen cleaning device according to claim 9 wherein the retainer member is fastened to the support member using an ultrasonic welding process that causes the plurality of fastening material members to melt and adhere the retainer member to the support member.

12. A screen cleaning device according to claim 9 wherein the covering is provided by at least one of a microfiber material, a suede material, a micro-suede material, and a soft fabric material; and wherein the block member is provided by at least one of a hard foam material and a felt material.

13. A method of manufacturing a screen cleaning device that includes a support member, a cleaning member that is matingly connectable to the support member, and a retainer member, the method comprising:
positioning a portion of the cleaning member to be carried by an interior portion of the support member; and
slidably positioning the retainer member about the cleaning member to fasten the support member to the cleaning member;
wherein the cleaning member comprises a pad and a covering overlying the pad.

14. A method according to claim 13 wherein the pad further comprises an insert member and a block member carried by the insert member;
and further comprising adhesively connecting the block member to the insert member.

15. A method according to claim 14 wherein the covering is provided by at least one of a microfiber material, a suede material, a micro-suede material, and a soft fabric material; and wherein the block member is provided by at least one of a hard foam material and a felt material.

16. A method according to claim 14 wherein the insert member comprises a plurality of tabs having an orientation; and wherein the support member includes a respective plurality of tab receiving recesses formed therein having an orientation substantially similar to the orientation of the plurality of tabs.

17. A method according to claim 16 further comprising matingly engaging the plurality of tabs of the insert member with the respective plurality of tab receiving recesses formed in the support member.

18. A method according to claim 13 wherein the support member comprises a plurality of fastening material members; and wherein the retainer member is fastened to the support member using an ultrasonic welding process that causes the plurality of fastening material members to melt and adhere the retainer member to the support member.

19. A method according to claim 13 wherein at least one of the retainer member and the support member includes fastening members; wherein at least one of the support member and the retainer member includes a respective plurality of fastening member recesses; and further comprising matingly engaging the fastening members to the respective plurality of fastening member recesses to fasten the retainer member to the support member.

20. A method according to claim 13 further comprising fastening the retainer member to the support member using a male/female fastening system.
